(19) United States
(12) Patent Application Publication
(10) Pub. No.: US 2014/0237886 A1
(43) Pub. Date: Aug. 28, 2014

(54) FISHING LINE RELEASE CLIP

(71) Applicant: Keith TABOADA, Brielle, NJ (US)

(72) Inventor: Keith TABOADA, Brielle, NJ (US)

(21) Appl. No.: 13/775,225

(22) Filed: Feb. 24, 2013

(51) Int. Cl. A01K 97/12

(52) U.S. Cl. CPC A01K 97/125
USPC 43/4.5; 43/17

(57) ABSTRACT

A line release clip that generates an electronic alert upon opening independent of the release tension adjustment is provided. In one embodiment, the line release clip includes a body, a line retainer coupled to the body, a release adjustment mechanism and a release alarm. The line retainer is rotatable between a closed position and an open position. The release adjustment mechanism is operable to control force required to move the line retainer from the closed position. The release alarm is operable to emit at least one of an audible sound or light in response to the line retainer moving from the closed position, thereby alerting fisherman of the release of the fishing line from the clip.

### BACKGROUND OF THE INVENTION

1. Field of the Invention

Embodiments of the invention generally relate to a line release clip for holding fishing line, and more specifically, a line release clip suitable for use in flat line, kite and outrigger fishing line applications.

2. Background

Line release clips, such as outrigger clips, kite release clips and flat line clips, are generally utilized to hold fishing line in a location remote from the rod tip in a manner that releases the fishing line from the clip once a fish strikes a bait or lure. The primary manufactures of these types of clips are RUPP MARINE, INC., of Port Salerno, Fla., AFTCO MFG. CO. INC., of Irvine, Calif., BLACKS MARINE, and MALIN COMPANY INC., of Cleveland, Ohio. Conventional clips have adjustable tension releases that control the amount of line pull required to release the fishing line from the clip. The fishing line must be inserted into the clip as the tension release is closed. This often is difficult particularly for clips used on outriggers where a person must lean outward over the rail of the rocking boat while holding the line being pulled through the water in one hand while both holding the clip and closing the tension release in the other. Additionally, the sound of the clip opening against the tension release is not audible at a level sufficient to be heard by persons in the boat, particularly when the boat is underway.

Thus, there is a need for an improved line release clip.

### SUMMARY OF THE INVENTION

In one embodiment, a line release clip is provided that generates an alert signal upon opening independent of a release tension adjustment. In one embodiment, the line release clip includes a body, a line retainer coupled to the body, a release adjustment mechanism and a release alarm. The line retainer is rotatable between a closed position and an open position. The release adjustment mechanism is operable to control force required to move the line retainer from the closed position. The release alarm is operable to produce an alert signal in response to the line retainer moving from the closed position, thereby alerting fisherman of the release of the fishing line from the clip. The alert signal may be an electronic alert signal detectable from a cockpit of a fishing vessel. The alert signal may be in the form of one or both of an audible electronic sound and a visual (i.e., light) signal. The alert signal may be in the form a communication signal which may be received on board the vessel.

### BRIEF DESCRIPTION OF THE DRAWINGS

The teachings of the present invention can be readily understood by considering the following detailed description in conjunction with the accompanying drawings, in which:

FIG. 1 is a perspective view of one embodiment of a line release clip of the present invention;

FIG. 2 is an exploded view of one embodiment of the line release clip of FIG. 1;

FIG. 3 is a cut-away side view of the line release clip of FIG. 1 with the line retainer in a closed position;

FIG. 4 is a cut-away side view of the line release clip of FIG. 1 with the line retainer in an open position; and

FIG. 5 is a schematic diagram of a control panel configured for communicating with embodiments of a line release clip having a transmitter.

To facilitate understanding, identical reference numerals have been used, where possible, to designate identical elements that are common to the figures. It is contemplated that elements and features of one embodiment may be beneficially incorporated in other embodiments without further recitation.

It is to be noted, however, that the appended drawings illustrate only exemplary embodiments of this invention and are therefore not to be considered limiting of its scope, for the invention may admit to other equally effective embodiments.

### DETAILED DESCRIPTION

Embodiments of the present invention generally provides a line release clip having an electronically generated alert signal which is independent of the tension adjustment utilized to release a line from the clip. The alert signal may be in the form of an audible report (e.g., sound) and/or light which is not the mechanical noise generated by the release clip opening. The alert signal advantageously allows the tension adjustment of the clip to be set to allow slight line pulls to release the fishing line retained by the clip while providing an alert signal that the clip has opened. The mechanical noise generated by conventional release clips opening typically cannot be heard when opening under light tension adjustments.

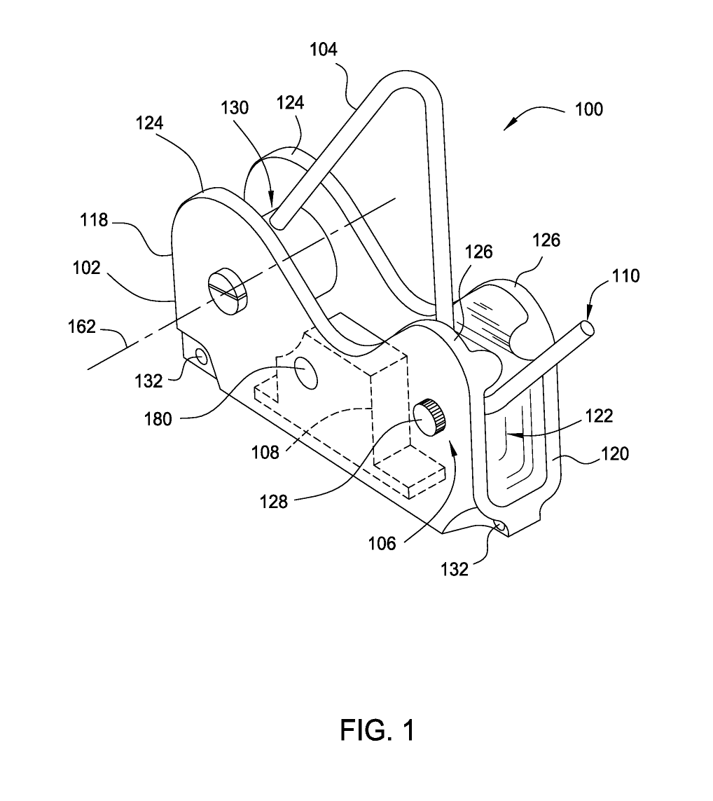

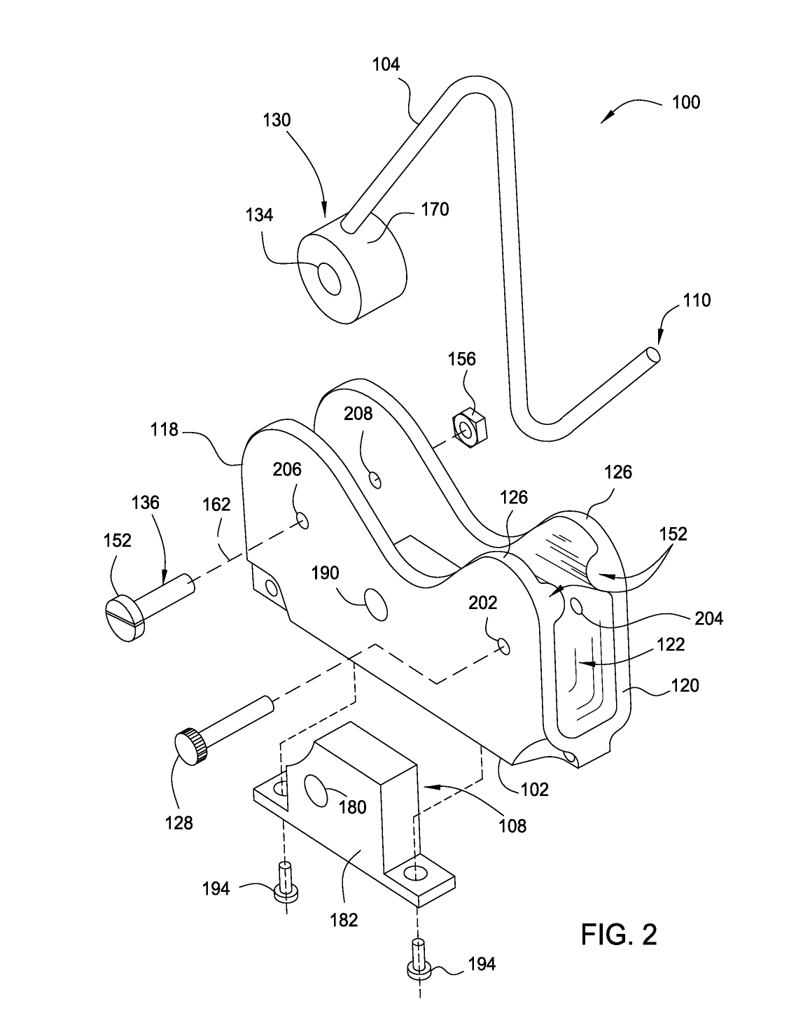

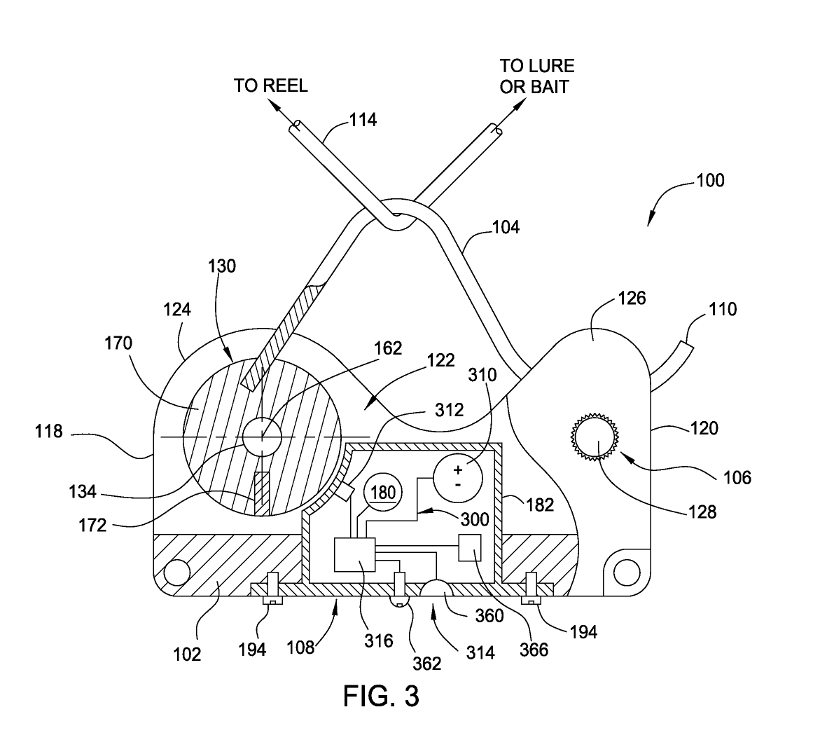

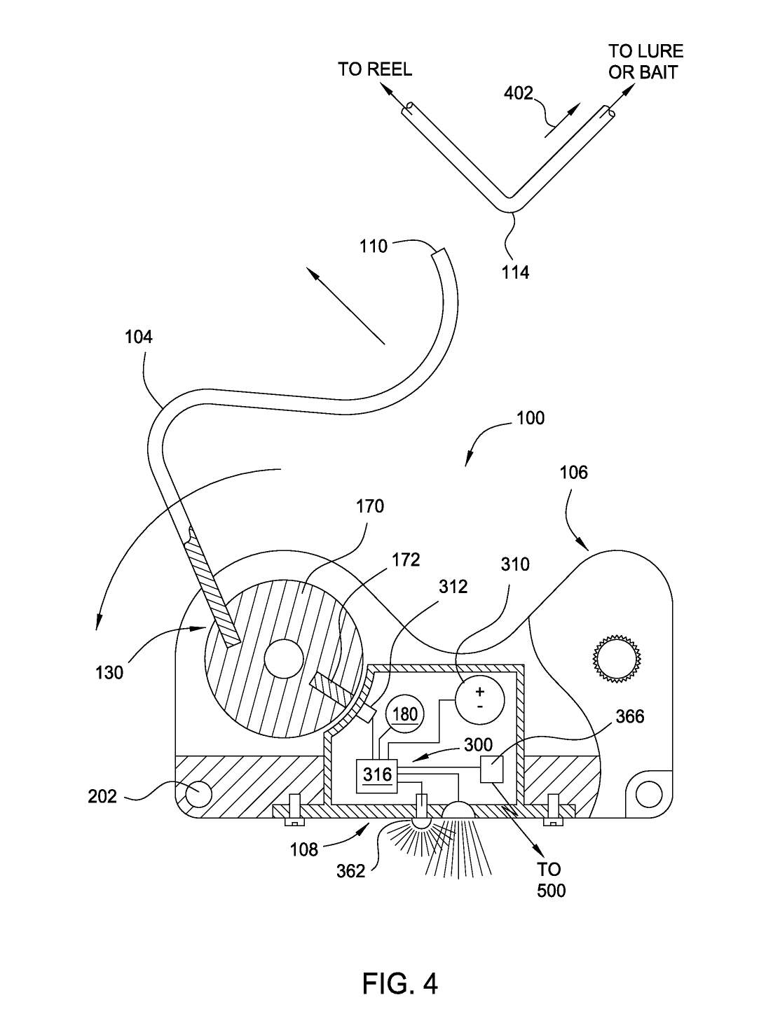

FIGS. 1-2 are perspective and exploded perspective views of one embodiment of a line release clip 100. The line release clip 100 includes a body 102, a line retainer 104, a release adjustment mechanism 106 and an electronic release alarm 108. The line retainer 104 is rotationally coupled to the body 102. The release adjustment mechanism 106 controls the amount of force necessary to rotate the line retainer 104 from a closed position to an open position. The line retainer 104 is shown in the closed position in FIG. 1 and FIG. 3, and shown in the open position in FIG. 4. In the closed position, a distal end 110 of the line retainer 104 is releasably held adjacent the body 102 such that a fishing line 114 is captured between the line retainer 104 and the body 102 as shown in FIG. 3. In the open position, a distal end 110 of the line retainer 104 is rotated about a captured end 130 of the line retainer 104 such that the distal end 110 of the line retainer 104 rotates away from the body 102 to a position which allows fishing line 114 to escape the clip 100 (as shown by arrow 402 depicted in FIG. 4).

Continuing to refer to FIGS. 1-2, the release alarm 108 operates to provide a signal when the distal end 110 the line retainer 104 moves from the closed position to the open position when the fishing line 114 escapes the clip 100. The signal may be an audible and/or a visual signal, the strength of which is independent of the setting of the release adjustment mechanism 106.

In one embodiment, the audible signal of the release alarm 108 is over and above the sound of any sound that may be generated by the release adjustment mechanism 106 and/or the line retainer 104 hitting the body 102. Advantageously, the release alarm 108 operates independently of the release adjustment mechanism 106, such that adjustments to the release adjustment mechanism 106 will not change the audible signal generated by the release alarm 108. This is particularly advantageous when the release adjustment mechanism 106 is set to allow the fishing line 114 escape the clip 100 with a very slight line pull, conditions wherein the opening of conventional clips often cannot be heard. Additionally, the release alarm 108 serves to notify the angler that the fishing line 114 has been pulled from the clip 100 even when line is not pulled from the fishing reel, such as when a small amount of weed is picked up on a lure.

In one embodiment, the body 102 has a generally elongated form, with a mounting aperture 132 disposed at opposite ends 118, 120. The mounting aperture 132 facilitates coupling the body 102 to a halyard of the outrigger, center rigger, kite line or other mounting location, such the transom of the boat (i.e., used to hold a flat line). The mounting aperture 132 may be a hole formed through opposite ends 118, 120 of the body 102, a wire loop, or other suitable halyard attachment point.

The body 102 may be fabricated from any material suitable for use in a marine environment. In one embodiment, the body 102 is fabricated from plastic material. Alternatively, the body 102 may be fabricated from other plastic or metal materials.

The body 102 has a recess 122, such as a slot, which accepts a portion of the line retainer 104. In the embodiment depicted in FIG. 1, the body 102 includes two tabs 124 formed at the first end 118 and two tabs 126 formed at the second end 120. The recess 122 is defined at least partially between the two tabs 126. The recess 122 may also defined at least partially between the two tabs 124.

The tabs 126 also comprise part of the release adjustment mechanism 106. The release adjustment mechanism 106 includes an adjustment screw 128 that sets the distance between the tabs 126. In the embodiment depicted in FIG. 1, the adjustment screw 128 passes through a hole 202 formed in one tab 126 and threads into a threaded hole 204 formed in the opposite tab 126. The distal end 110 of the line retainer 104 is clamped between the tabs 126 when the line retainer 104 is in the closed position. The facing surfaces of the tabs 126 may include one or more retaining features 152, such as a rib, groove, roughened surface and the like, to more securely grip the line retainer 104 when positioned between the tabs 126. The adjustment screw 128 may be loosened or tightened to change the clamping force, and thus, set the force required to pull the line retainer 104 from between the tabs 126 into the open position to release the fishing line 114 from the clip 100 as known in the art. It is contemplated that other types of release adjustment mechanisms may be utilized, such as, but not limited to, those utilized by RUPP, AFTCO, MALIN and BLACKS, among others.

The captured end 130 of the line retainer 104 is rotatably coupled to the body 102. In one embodiment, the captured end 130 is deposed in the recess 122 defined between the two tabs 124 formed at the first end 118 of the body 102. In one embodiment, the captured end 130 is secured in a bushing 170 disposed between the tabs 124. The bushing 170 has an aperture 134. A shaft 136 is disposed through the aperture 134 and the two tabs 124 and defines an axis 162 upon which the line retainer 104 rotates. The shaft 136 may be a threaded rod, spring pin, dowel pin, rivet or fastener, and in the embodiment depicted in FIGS. 1-2, the shaft 136 is a bolt 154 extending though holes 206, 208 formed in the tabs 124 that screws into a nut 156, thereby securing the bushing 170 and line retainer 104 to the body 102, while allowing the line retainer 104 to rotate about the axis 162.

While the line retainer 104 is shown as a wire form, the line retainer 104 may alternatively be in the form of a roller. The line retainer 104 may also be configured to rotate about an axis aligned with the orientation of the body 102, similar to Nok-Outs® release clips, available from Rupp Marine.

Referring primarily now to the cut-away view of the release clip 100 depicted in FIG. 3, the bushing 170 also includes a position indicator 172. The position indicator 172 may be detected by a sensor 312 of the release alarm 108 in a manner that allows the release alarm 108 to resolve if the line retainer 104 is in the open position, or alternatively, not in the closed position. In one embodiment, the position indicator 172 is element which may be sensed by sensor 312 of the release alarm 108, such as a hole or rib, in instances where the sensor 312 is a mechanical switch. In the embodiment depicted in FIG. 1, the position indicator 172 is a magnetic material, such as steel, for example 440 series stainless steel, the proximity of which may be detected by the sensor 312.

As discussed above, the release alarm 108 operates to provide an audible signal when the distal end 110 the line retainer 104 moves from the closed position to the open position when the fishing line 114 escapes the clip 100.

The release alarm 108 may include a switch 180 which operates to set the mode of release alarm 108. The modes may release alarm 108 may include one or more of the on and off state of the release alarm 108, the type of the alarm generated by the release alarm 108, and the magnitude of the alarm generated by the release alarm 108, among others. The switch 180 is exposed to an exterior of the body 102, and in one embodiment, the switch 180 is in the form of a button disposed through an aperture 190 formed through the body 102. The button may be depressed to sequence the release alarm 108 through its modes. Alternatively, the mode of the release alarm 108 may be set remotely, for example, via a wireless signal, such as Bluetooth, RF, infrared or other wireless communication.

In one embodiment, the release alarm 108 is disposed in a housing 182. The housing 182 may be secured to the body 102, for example, by one or more screws 194. The housing 182 may be secured to the body 102 by other methods, such as snap fit or adhesive.

Continuing to refer to the cut-away view of the release clip 100 depicted in FIG. 3, the release alarm 108 includes an electronic circuit 300 which, in one embodiment, emits at least one of an electrically generated audible signal, an electrically generated visual (i.e., light) signal or a communication signal in response to the line retainer 104 moving from the closed position and/or being in the open position. The signal emitted by the release alarm 108 may be in response to motion and/or position of the line retainer 104, the shaft 136 or portions of the release adjustment mechanism 106.

In embodiments wherein the release alarm 108 emits a visual signal in response to the line retainer 104 moving from the closed position, the visual signal may be a strobe, flash, LED light or other light emitter. In embodiments wherein the release alarm 108 emits an audible signal in response to the line retainer 104 moving from the closed position, the audible signal may be a chirp, beep, siren, or other sound signal. Optionally, the release alarm 108 may emits both an audible signal and visual signal that operates substantially independent of the release adjustment mechanism 106.

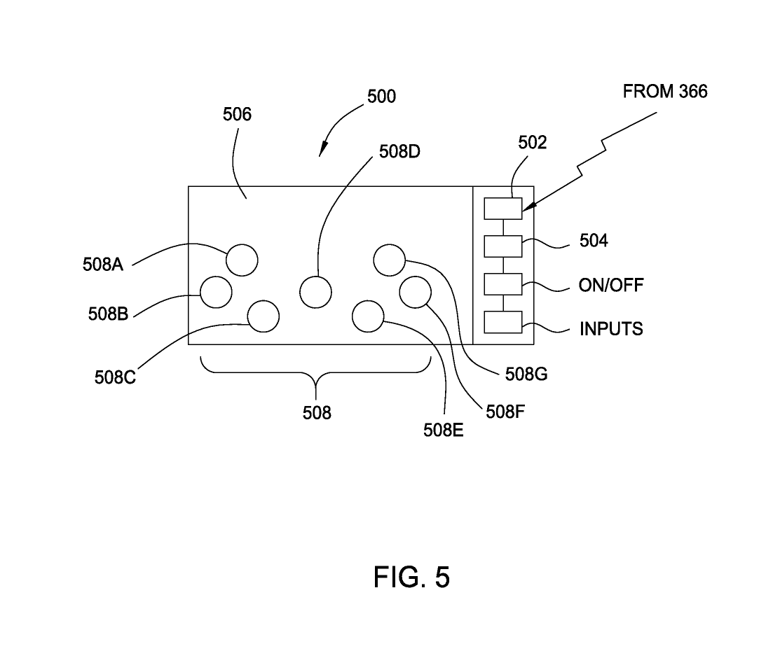

The release alarm 108 may alternatively, or in conjunction with generating one or both of audible and visual signals, generate a communication signal in response to the line retainer 104 moving from the closed position. The communication signal may be via a wireless signal, such as Bluetooth, RF, infrared or other wireless communication for triggering an alarm on a nearby, i.e., on-board the vessel, on a remote receiver 500, as further discussed below with reference to FIG. 5.

In one embodiment the electronic circuit 300 of the release alarm 108 that includes a battery 310, the switch 180, the sensor 312 and at least one electronic signal generator 314. The sensor 312 may be a proximity sensor, limit switch, hall-effect sensor, encode accelerometer or other sensor suitable for detecting an indicia of the position and/or movement of the line retainer 104. The circuit 300 may optionally include a logic circuit 316 that controls the mode of the release alarm, which may also include the sound and/or light created by the signal generator 314 such that one line release clip 100 may be set to be different than another release clip utilized on the boat so the angler may know which clip has released when a number of clips are being utilized in a conventional trolling situation. For example, the logic circuit 316 may be set to cause the signal generator 314 of one line release clip to generate a signal different than that of another line release clip, for example, different audio signals, different color lights, different light flashing rates, and the like.

In one embodiment, the at least one signal generator 314 may include an electronic audio signal generator 360. The audio signal generator 360 may be a speaker, buzzer, vibrator or other electronic sound generator. In another embodiment, the at least one signal generator 314 may include an electronic visual signal generator 362. The visual signal generator 362 may be a strobe, flash, LED light or other light emitter. In embodiments wherein both a sound and visual alert signals are desirable, both signal generators 360, 362 may be operably coupled to the logic circuit 316 and selectively actuated in response to the state of the sensor 312. It is contemplated that simpler designs may omit the logic circuit 316 and may have the sensor 312 directly interfaced with the signal generator(s) 314.

In yet embodiment, the at least one signal generator 314 may include an electronic communication signal generator 366. The communication signal generator 366 may be in the form of a transmitter configured to communicate over short distances with a remote electronic device. For example, the communication signal generator 366 may generate a signal in response to the opening of the line retainer 104, wherein the signal is a Bluetooth signal, an RF signal, an infrared signal or other signal suitable for communicating with a nearby remote receiver 500 on board the vessel. The logic circuit 316 may be set to allow the remote receiver 500 to identify and differential each unique release clip 100 so that fisherman know from which clip 100 the signal is coming from when multiple clips 100 are in use.

In embodiments wherein one or both of both a sound and visual alert signals are desirable in addition to generation of a communication signal, one or both of the signal generators 360, 362 along with the communication signal generator 366 may be operably coupled to the logic circuit 316 and selectively actuated in response to the state of the sensor 312.

In the embodiments depicted in FIG. 3 and FIG. 4, the sensor 312 is disposed in a position that senses a metric from which the position and/or motion of the line retainer 104 may be resolved. For example, the sensor 312 may be positioned to detect if the line retainer 104 has moved from the closed position or is in the open position. In the embodiment depicted in FIGS. 3-4, the position indicator 172 is spaced from the sensor 312 while the line retainer 104 is in the closed position, and positioned so as the line retainer 104 rotates to the open position, the position indicator 172 disposed in the bushing 170 rotates close enough to the sensor 312 to change the state of the sensor 312. For example, a position indicator 172 comprised of metal will cause the state of the sensor 312 to change when the sensor is configured as a proximity switch or magnetic sensor. As discussed above, it is contemplated that other types sensors 312 may also be utilized to detect the position and/or motion of the line retainer 104, for example limit switches, optical sensors, and encoders, among others.

When the distal end 110 of the line retainer 104 is moved from the closed position, the sensor 312 changes state which causes power from the battery 310 to be provided signal generator 314, thereby creating an electronic audible and/or visual alert signal that the fishing line 114 has been released from the clip 100. As discussed above, the alert signal provided by the release alarm 108 is generated substantially independently from the setting to the release adjustment mechanism 106. For example, the tension on the release adjustment mechanism 106 may be tightened or loosened without changing the operation of the release alarm 108.

As discussed above, the release alarm 108 may alternatively or in addition to providing an audible and/or visual signal, provide a communication signal in response to the change in state of the sensor 312. In such embodiments, the change in state of the sensor 312 may causes power from the battery 310 to be provided to the communication signal generator 366, which transmits a signal to the remote receiver 500, as further discussed below, which may be located in a convenient location on a fishing vessel.

Referring now to the schematic diagram of FIG. 5, one embodiment of the remote receiver 500 includes a transmission receiver 502, a processor 504 and a display 506. The remote receiver 500 may also include on/off switch and inputs, such as buttons for user communication with the processor 504. The transmission receiver 502 is configured to receive the signal from the release alarm 108 as discussed above. The processor 504 is programmed by the user to associate individual release clips 100 with an associated one of a plurality of indicators, exemplarily shown as indicators 508A through 508G and collectively referred to as indicators 508. In response to receiving a signal indicative a predefined one of the release clips 100 indicating a change in state of the sensor 312, i.e., the opening of the line retainer 104, the processor 504 causes the associated indicator 508 to actuate, for example, emit a light or sound. For example, Table 1 below provides an exemplary association between indicators 508 and release clips 100 disposed in predefined positions on a sport fishing vessel.

TABLE 1

| Indicator 508 | Location of the Clip 100 |
|---|---|
| 508A | Port Long Rigger |
| 508B | Port Short Rigger |
| 508C | Port Flat Line |
| 508D | Center Rigger |
| 508E | Starboard Flat Line |
| 508F | Starboard Short Rigger |
| 508G | Starboard Long Rigger |

Thus, when the release clip 100 on the port long rigger opens, the indicator 508A will activate, thus indicating a fish, strike, weed, or the like on a specific fishing rod on port long rigger. Likewise, activation of indicator 508F will indicate activity (i.e., opening of the line retainer 104) on the starboard short rigger, and so on.

Although various embodiments which incorporate the teachings of the present invention have been shown and described in detail herein, those skilled in the art can readily devise many other varied embodiment that still incorporate these teachings.

What is claimed is:

1. A line release clip comprising:
a body;
a line retainer having a captured end coupled to the body, the line retainer rotatable between a closed position and an open position;
a release adjustment mechanism operable to control force required to move the line retainer from the closed position; and
a release alarm coupled to the body and operable to emit at least one of an electronic visual alert signal and an electronic audible alert signal in response to the line retainer moving from the closed position.

2. The line release clip of claim 1, wherein the release alarm comprises:
an electronic audible sound generator.

3. The line release clip of claim 2, wherein the electronic audible sound generator is a speaker, a buzzer or a vibrator.

4. The line release clip of claim 1, wherein the release alarm comprises:
an electronic visual signal generator.

5. The line release clip of claim 4, wherein the electronic visual signal generator is a strobe light, a flash light, or an LED light.

6. The line release clip of claim 1, wherein the release alarm comprises both an electronic visual signal generator and an electronic audible sound generator.

7. The line release clip of claim 1, wherein the release alarm comprises:
a battery.

8. The line release clip of claim 1, wherein the release alarm comprises:
a switch configured to turn the release alarm on and off.

9. The line release clip of claim 1, wherein the release alarm further comprises:
a sensor coupled to the body and configured to sense an indicia of a position of the line retainer.

10. The line release clip of claim 6, wherein the sensor interfaces with a captured end of the line retainer to sense the indicia of the position of the line retainer.

11. An outrigger line release clip comprising:
a plastic body having mounting apertures at oppose ends and configured to couple the body to a halyard of an outrigger;
a line retainer coupled to the body, the line retainer having a closed position configured to capture a fishing line to the clip and an open position configured to capture release the captured fishing line from the clip;
a release adjustment mechanism operable to control force required to move the line retainer from the closed position; and
a release alarm coupled to the body and having a sensor operable to detect an indicia of the position of the line retainer, the release alarm having at least one of an electronic audio signal generator and an electronic visual signal generator operable to generate a signal in response to a change is state of the sensor.

12. The line release clip of claim 11, wherein the electronic audible sound generator is a speaker, a buzzer or a vibrator.

13. The line release clip of claim 11, wherein the electronic visual signal generator is a strobe light, a flash light, or an LED light.

14. The line release clip of claim 11, wherein the release alarm comprises both an electronic visual signal generator and an electronic audible sound generator.

15. The line release clip of claim 11, wherein the release alarm comprises:
a battery; and
a switch configured to turn the release alarm on and off.

16. A method for alerting release of a fishing line from an outrigger line release clip, the method comprising:
emitting an electronic alert signal in response to a metric indicative of a line retainer of an outrigger line release clip moving from a closed position, wherein the alert signal does not change in response to adjustments made to control the force needed to move the line retainer.

17. The method of claim 16, wherein emitting further comprises:
electrically generating a sound.

18. The method of claim 18, wherein emitting further comprises:
electrically generating a light.

19. The method of claim 18, wherein electrically generating the light further comprises:
generating at least one of a strobe light, a flash light or an LED light.

20. The method of claim 18, wherein emitting further comprises:
electrically generating a sound.
